(19) United States
(12) Patent Application Publication
(10) Pub. No.: US 2017/0091861 A1
(43) Pub. Date: Mar. 30, 2017

(54) System and Method for Credit Score Based on Informal Financial Transactions Information

(71) Applicant: International Business Machines Corporation, Armonk, NY (US)

(72) Inventors: Silvia Cristina Sardela Bianchi, Sao Paulo (BR); Heloisa Caroline De Souza Pereira Candello, Sao Paulo (BR); David Ryant Millen, Rockport, MA (US); Claudio Santos Pinhanez, Sao Paulo (BR)

(21) Appl. No.: 14/863,470

(22) Filed: Sep. 24, 2015

(51) Int. Cl. G06Q 40/02

(52) U.S. Cl. CPC G06Q 40/025

(57) ABSTRACT

In reply to a requester's credit request, a plurality of the requester's debtors are selected, each of which has a payment due to the requester during the repayment period. Repayment information for is retrieved for each debtor as is the requester's cash flow. A repayment probability score per debtor is computed based on the debtor's repayment history and the debtors are ranked based on the repayment probability score and an amount of the debtor's payments due. Debtors are further selected in order of rank until a total of their payment amounts at least equals a payment amount per installment. The computed repayment probability scores of the further selected debtors are aggregated into a bundle score, and a new credit score is computer for the credit request based on at least the bundle score, without reliance on information that may be used to identify any of the debtors.

### TECHNICAL FIELD

The exemplary embodiments of this invention relate generally to cognitive credit scoring of informal financial transactions, and example embodiments encompass credit scoring of merchant receivables from informal transactions with multiple customers which may be used to obtain a loan for sustaining and/or expanding the merchant's business.

### BACKGROUND

When providing loans to customers and entrepreneurs, bank assess the risk by verifying financial data from them such as monthly income, credit history, bill payment and transactions history, and the like, and the loan is provided if all this information fulfils the loan risk requirements. But analyzing the risk of the unbanked and underbanked population is a challenge. Most of these populations do not have credit and transaction history data which makes it difficult for the banks to evaluate their repayment risk. Many times such non-traditional prospective borrowers will themselves use informal financial practices such as lending among friends and within their own neighborhood. Another common practice is to sell goods in exchange for a promise to pay later (such as in a month or more) when the customer is expected to have money to repay the informal loan. In many of these cases the payment due dates are uncertain and somewhat malleable among the parties, which also means uncertainty in when these informal lenders will themselves be paid back. These types of informal transactions involve trust between the parties.

FIG. 1 gives an overview of the credit flow in such a non-traditional transaction. A merchant sells some goods or provides some service to a customer at part A using some sort of non-traditional financial arrangement such as an oral promise to pay or a barter arrangement where the customer provides his end of the bartered goods/services at some alter time. For simplicity assume the non-traditional financial arrangement includes the sale of goods by the merchant and repayment of money by the customer. At part B the merchant writes the purchase and repayment date in some personal notebook that he/she uses to track such informal transactions. Once the customer pays back the merchant on the agreed date and in the agreed amount at part C the merchant manually removes the transaction from his notebook at part D. With that repayment money in hand the merchant can use the money in a conventional transaction with some supplier to re-stock his/her shelves or purchase new inventory at part E. Once the merchant receives that re-stock or new inventory he/she makes it available for sale at part F and the cycle continues.

In the FIG. 1 example the merchant has sold the goods at part A but has no capital to re-stock his/her shelves until part C, and the time involved reflects the repayment terms, which may be weekly or monthly if on installments but for repayment of the entire amounts due it is the entire term of the loan. What is needed in the art is a way to more formally assess loan risk to a party such as a neighborhood merchant that is expecting repayment on several such informal transactions. This would enable more traditional lenders such as banks to fairly assess the risk of loaning to a merchant who has ‘receivables’ from various informal transactions on which the merchant is the lender, which in turn enables the merchant to re-stock inventory without having to wait for payment on previously-sold inventory.

### SUMMARY

In a first aspect thereof the embodiments of this invention provide a method performed on at least one computing device, the method comprising: receiving a requester's credit request comprising a reason, a credit amount, a repayment period and a number of installments; and in response:
selecting a plurality of the requester's debtors each of which has a payment due to the requester during the repayment period;
retrieving, for each of the selected debtors, respective repayment information for the repayment period;
retrieving the requester's cash flow information;
computing a balance per installment for the repayment period;
computing an accumulated balance for the repayment period;
for the case in which the accumulated balance is greater than the credit amount of the request, computing, for each of the selected debtors, a repayment probability score based on at least the respective debtor's repayment history prior to the repayment period;
ranking the selected debtors based on the repayment probability score and an amount of the debtor's respective payment due per installment for the repayment period;
further selecting the debtors in order of rank until a total of the amounts of the payments due per installment of the further selected debtors at least equals a payment amount of the respective installment;
aggregating the computed repayment probability scores of the further selected debtors into a bundle score; and
computing a new credit score corresponding to the requester's credit request based on at least the bundle score and without reliance on information that may be used to identify any of the selected debtors.

In another aspect thereof the embodiments of this invention provide an apparatus comprising one or more memories comprising computer-readable code and one or more processors. The one or more processors are configured, in response to execution of the computer-readable code, to cause the apparatus to perform actions comprising: in response to receiving a requester's credit request comprising a reason, a credit amount, a repayment period and a number of installments:
select a plurality of the requester's debtors each of which has a payment due to the requester during the repayment period;
retrieve, for each of the selected debtors, respective repayment information for the repayment-period;
retrieve the requester's cash flow information;
compute a balance per installment for the repayment period;
compute an accumulated balance for the repayment period;
for the case in which the accumulated balance is greater than the credit amount of the request compute, for each of the selected debtors, a repayment probability score based on at least the respective debtor's repayment history prior to the repayment period;
rank the selected debtors based on the repayment probability score and an amount of the debtor's respective payment due per installment for the repayment period;
further select the debtors in order of rank until a total of the amounts of the payments due per installment of the further selected debtors at least equals a payment amount of the respective installment;
aggregate the computed repayment probability scores of the further selected debtors into a bundle score; and
compute a new credit score corresponding to the requester's credit request based on at least the bundle score and without reliance On information that may be used to identify any of the selected debtors.

In a further aspect thereof the embodiments of this invention provide a computer readable memory storing program code that is executable by a computing system to cause the computing system to perform: receiving a requester's credit request comprising a reason, a credit amount, a repayment period and a number of installments; and in response:
selecting a plurality of the requester's debtors each of which has a payment due to the requester during the repayment period;
retrieving, for each of the selected debtors, respective repayment information for the repayment period;
retrieving the requester's cash flow information;
computing a balance per installment for the repayment period;
computing an accumulated balance for the repayment period;
for the case in which the accumulated balance is greater than the credit amount of the request, computing, for each of the selected debtors, a repayment probability score based on at least the respective debtor's repayment history prior to the repayment period;
ranking the selected debtors based on the repayment probability score and an amount of the debtor's respective payment due per installment for the repayment period;
further selecting the debtors in order of rank until a total of the amounts of the payments due per installment of the further selected debtors at least equals a payment amount of the respective installment;
aggregating the computed repayment probability scores of the further selected debtors into a bundle score; and
computing a new credit score corresponding to the requester's credit request based on at least the bundle score and without reliance on information that may be used to identify any of the selected debtors.

### BRIEF DESCRIPTION OF THE DRAWINGS

FIG. 1 is a schematic flow diagram illustrating certain events in a financial transaction between a merchant and a customer, and how it affects the merchant's ability to serve other customers.

FIG. 2 is a schematic diagram illustrating several aspects of these teachings for assessing a merchant's repayment risk based on the merchant's receivables from informal transactions with multiple customers.

FIG. 3 is a schematic diagram of an exemplary local device for assessing a merchant's credit score by aggregating a merchant's informal transactions into a debit bundle according to certain embodiments of these teachings.

FIG. 4 is a table showing certain aspects of how a merchant's expected repayments on informal transactions with multiple customers can be used to generate a debit bundle score according to certain embodiments of these teachings.

FIG. 5 is a logic flow diagram illustrating a method that encompasses certain features of the embodiments of this invention.

### DETAILED DESCRIPTION

Embodiments of these teachings concern a credit scoring model that uses information from informal financial transactions such as those outlined in the background section above. The model that is presented herein by example and not by way of limitation can be combined with traditional information, if available, such as past transaction history and personal data of the merchant's individual customers as well as the merchant him/herself.

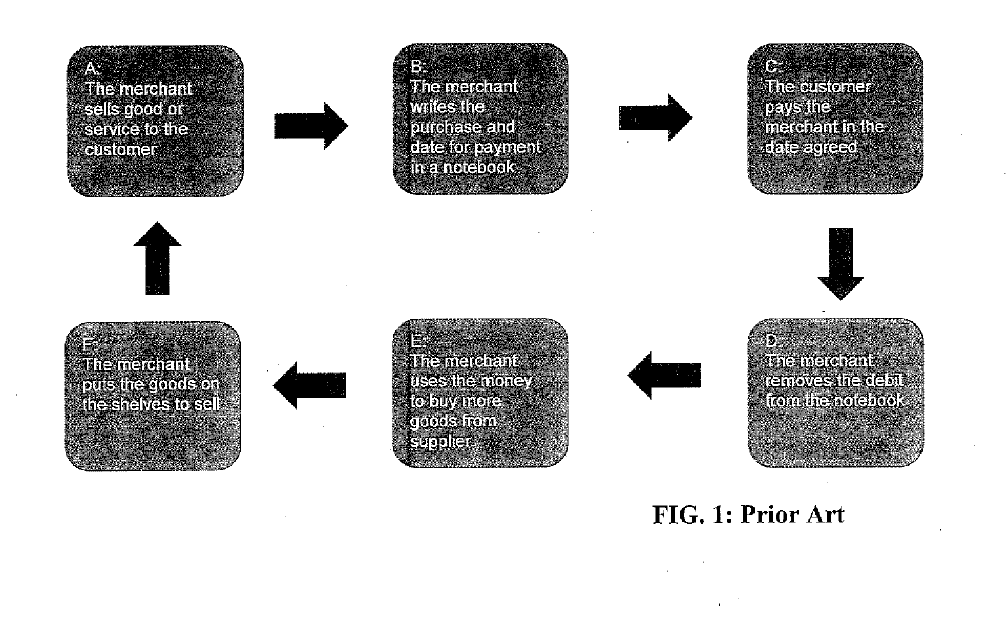

It is known to generate a financial credit score based on consumer financial data (U.S. Pat. Nos. 7,925,582 and 7,877,304) or financial transactions (US 2014/0156501). Calculating an anticipated credit score is also known (US 2012/0278227), as is the use of hypothetical values for simulating a credit score (U.S. Pat. No. 8,335,741). Other techniques are to calculate a property value based on the owner's credit score (U.S. Pat. No. 8,494,792) and to base a credit score on a share of a wallet (US 2014/0012734; U.S. Pat. No. 8,447,689) or spending capacity information (U.S. Pat. No. 8,438,105). Credit scores can be improved by settling debts (U.S. Pat. No. 7,814,005), or improved for a motor vehicle loan by installing a location device (US 2013/0117173). Future credit scores can be predicted (US 2010/0268639) and credit scores can be used in real time when authorizing transactions (US 2010/0010930). Psychometrics interview data can be used in creditworthiness checks (US 2004.0177030) and can be done in the absence of traditional credit bureau data (U.S. Pat. No. 8,386,377). Credit scores can be based in personal data gathered from an online social footprint (U.S. Pat. No. 8,694,401) and different trust record sources can be used to build an aggregated trust profile (US 2010/0076987). Score reputation can be based on the reputation of online marketplace participants (US 2007/0192169), and there are also specific ways to evaluate a merchant's reliability (US 2008/0270209) as well as how to detect fraudulent online merchants (US 2011/0225076). But none of these are seen suitable for enabling a merchant that serves the unbanked or underbanked population to monetize his/her receivables from that population as outlined with respect to the FIG. 1 example.

Embodiments of these teachings include a system and method for cognitive credit score. Such a system contains models capable of learning from various types of data, including informal financial transactions and personal data, and is capable of adjusting and adapting dynamically as the system gains new knowledge with new incoming data. As mentioned in the background section, such informal transactions may include a promise of future payments from a client/customer in exchange for a service or good provided by a merchant. Normally during these informal transactions no cash is exchanged; the merchant provides to the client/customer the good or service to the client and writes the purchase in a notebook, such as the customer name, amount, date to repay, and the like.

In such a case, embodiments of these teachings first have the merchant enter the records from the notebook in the cognitive system that later will be used to generate a score of these customers. The score of these customers will then be used to score the credit of the merchant when that merchant applies for a loan. In broad terms this may be considered somewhat like invoice discounting or loans against accounts receivable, where the borrowing involves the use of the accounts receivable assets as collateral for the loan.

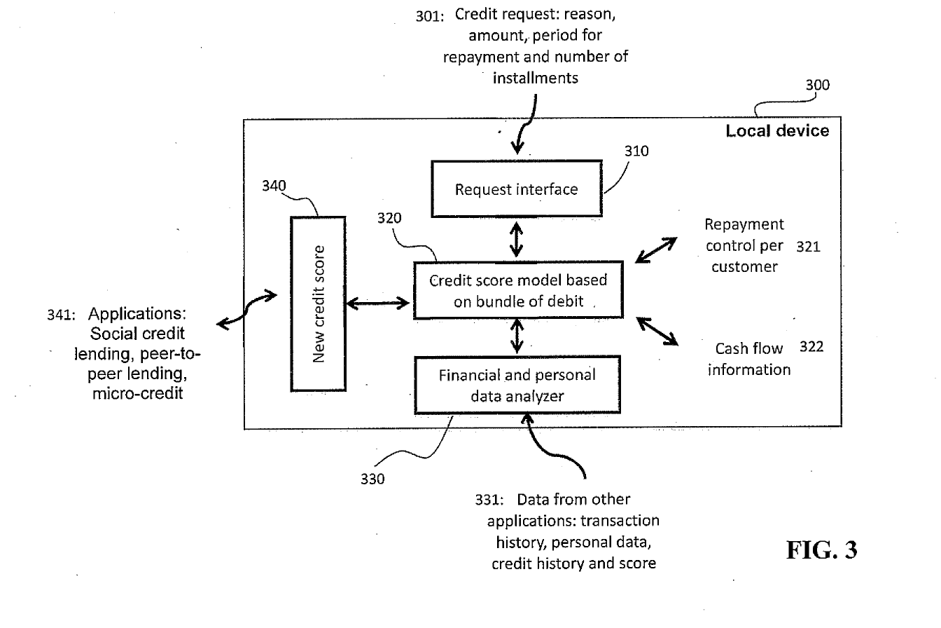

One aspect of these embodiments is that the responsibility for raising payment for the sales invoice and credit control stays with the merchant; the bank or other lending facility that provides the loan to the merchant has no access to the merchant's specific receivables for the informal transactions because the lending facility is given information on which to base its approve/disapprove decision for the loan that is insufficient to identify any of the merchant's individual informal transaction customers/debtors. In these embodiments no reports on the sales ledger and credit control process is sent to the lending facility/credit provider, which ensures the privacy of these unbanked/underbanked customers that enter into the informal financial transactions with the merchant. In this regard all the relevant processing is executed locally at the merchant's system. In the FIG. 3 embodiment the local device 300 generates a new credit score for the merchant for consideration by the facility/credit provider, or in other embodiments the local device 300 outputs cash flow projections for the loan repayment installment dates and a bundle score from which the facility/credit provider can compute the new credit score themselves, but in both cases the identity of the merchant's customers/debtors are not knowable by the facility/credit provider from the information that the merchant provides with its credit request.

To provide additional assurances to the lending facility the software running the cognitive credit scoring process on the merchant's system can provide the lending facility with certain security/non-corruption markers to prove the software has not been tampered with to alter the bundled score and/or new credit score that is output for consideration by the lending facility.

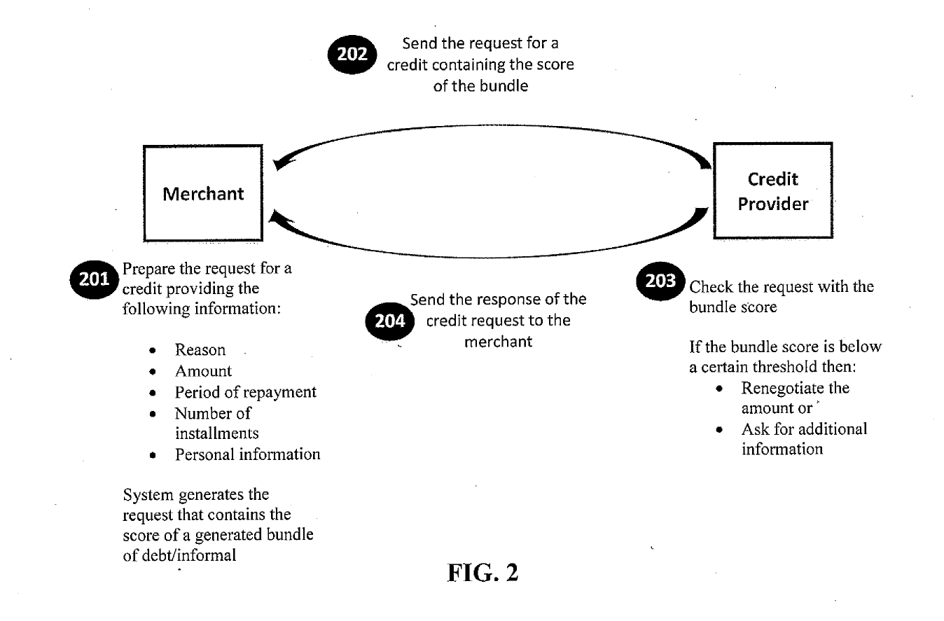

FIG. 2 presents schematic diagram illustrating an example of a scenario considered in this invention for a lending facility/bank to assess a merchant's repayment risk based on the merchant's receivables from informal transactions with multiple customers. When a merchant wants to apply for a credit or loan, at step 201 the merchant enters in the system all the information related to the request: for example the reason for the credit (e.g., to buy new furniture or to rebuild the merchant's store), the amount requested, the period for repayment (e.g., 1 month, 3 months), the number of installments, and the merchant's personal information such as name, address, phone number and account information which may be pre-stored in a profile established with the lending facility/bank.

The system is run locally, under control of the merchant since it needs access to the customer repayment information which is to be kept private from the lending facility itself. The system will aggregate the customer repayment information that is relevant to the merchant's loan request into a ‘bundle’ and establish a credit score for that bundle so that the bundle score can be provided to the lending facility/bank without revealing the financial information of the individual customers with whom the merchant has informal transactions that are relevant to the merchant's repayment of the loan he/she is requesting.

The system uses this information to select a set of informal transactions and to generate a score for this bundle. The bundle can include multiple customers, as well as multiple informal transactions from one or more individual customers. The score is based on the past transactions of the customers that are selected for the bundle, for example the customers that always pay on time will have a higher score than the ones that always pay late (assuming all other considered factors are equal). The customers selected for the bundle are those for which there is at least one payment due to the merchant, during the term of the merchant's requested loan and whose repayments are to support the merchant's own loan request, on an outstanding balance due to the merchant according to an informal transaction. Then the system generates or otherwise computes a unique score (the bundle score) from all the individual scores collected from the selected customers. So, for each different loan request by the merchant there will be a different bundle selected and the bundle score will be generated on that specific bundle.

With the bundle score now calculated, the merchant's loan request is then sent to the lending facility/credit provider at step 202 along with the bundle score to be analyzed for an approve/disapprove/modify decision. The lending facility/credit provider may be a bank, a peer-to-peer lending group, a micro-credit agency, an individual, or the like. The credit provider receives the merchant's loan request and checks the bundle score at step 203 of FIG. 2. Based on the score, the loan request may be approved or rejected. In one embodiment the software that computes the bundle score also outputs the approve/reject decision, and in other embodiments this is done separately by the credit provider.

As FIG. 2 summarizes further for step 203, if the score of the bundle is below a certain threshold, the credit provider may ask for additional information or reduce the amount that is approved to some amount less than the request. The response of the credit request is sent back to the merchant at step 204. In a particular embodiment the system generates only a bundle score for a set of the merchant's customers and no information about the individual customers or the specifics of their individual financial transactions with the merchant is provided to the credit provider—the bundle is completely anonymous as to the merchant's customers.

This is not to exclude embodiments in which the merchant's request ha's a blend of traditional and non-traditional transactions to be used as collateral or proof of the merchant's repayment ability; in one implementation all of the transactions supporting the loan request are bundled regardless of whether or not they are conventional credit/installment agreements, while in another implementation only the non-traditional financial transactions with the merchant are used to form the bundle score and other more conventional credit arrangements between the merchant and his/her customers are separately detailed to the credit provider as is conventional for financing a merchant's receivables from borrowers whose repayment risk can be evaluated conventionally. For simplicity in further detailing the more novel aspects of these teachings, the description below assumes the bundle score represents only the merchant's non-traditional financial arrangements which would typically be with the merchant's un-banked or under-banked customers.

The credit risk predictive models according to embodiments of these teachings can be built using statistical methods, and/or machine learning methods and/or artificial intelligence methods. Such methods correlate the various data in order to discover patterns and predict credit risk. Examples of machine learning and statistics techniques include but not limited to:
Supervised learning: such as decision trees, support vector machines, neural networks, case based reasoning, and k-nearest neighbor.
Unsupervised learning: such as self-organizing maps, k-means and expectation maximization.
Statistic based learning: such as logistic regression, naive bayes, discriminant analysis, and isotonic separation.
Other techniques include genetic algorithms, group method, fuzzy sets, and rules-based.

The credit risk predictive model according to these teachings can utilize one or more of the above techniques.

FIG. 3 is a schematic diagram showing one implementation of a local device for assessing a merchant's credit score according to certain embodiments of these teachings. In some embodiments the software analysis performed by the credit score model is resident in the local device 300. In general the local device 300 includes a request interface 310, a credit score model 320 and a financial and personal data analyzer 330. Either or both of the credit score model 320 and the financial and personal data analyzer 330 may be embodied as a computer-readable memory storing executable software or as a physical processing module. The relevant output of the local device 300 is a new credit score 340 which as mentioned above may be sent to various types of credit providers/lending facilities.

The request interface 310 receives the input for a credit request which includes at least the merchant's reason for the credit (for example to buy new furniture or rebuild the store), the amount requested, the period for repayment (for example 2 months or 6 months) and the total number of installments (for example 6 or 12 installment payments spread out over the repayment period).

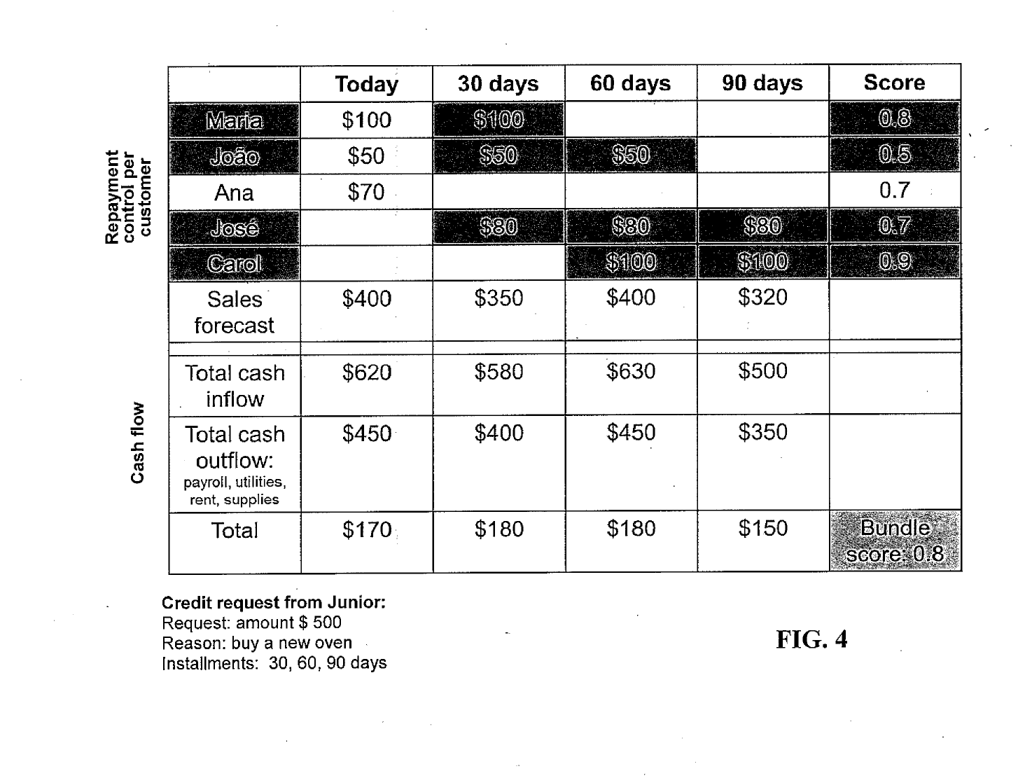

One type of information that is input into the credit score model is repayment control per customer 321, which includes the information about the debt per customer such as for example the customer's purchase history with date of purchase, date to pay, amount, type of good and historical debits that have been repaid and whether those repayments were on time or late (and if late by how much). FIG. 4 is a table showing such debt for several customers Maria, João, Ana, José and Carol, with the amounts due to the merchant on their respective informal transactions at the different 30-day-spaced columns.

Another type of information that is input into the credit score model is the merchant's cash flow information, which includes information about inventory, selling history and sales forecasts, and cash outflow such as utility, rent and supply expenses and payroll and the like so the model can calculate the balances at various dates during the credit repayment period. The lower portion of the table at FIG. 4 also shows this cash flow, where the cash inflow values include the merchant's new sales as well as the expected debt repayments that are listed from the various customers. Subtracting the total cash outflows for the various 30-day periods shows the merchant with a positive cash position of between $150 and $180 on each of those installment dates for the merchant's requested loan, but each of these assumes full repayment on time for each of the installments owed to the merchant by his customers.

The financial and personal data analyzer 330 of FIG. 3 takes its inputs from external sources of information and concerns the individual customers who have a payment due to the merchant during the requested loan repayment period as well as the merchant himself/herself. For the merchant such external sources of information may include banks, credit agencies, current or previous creditors, and the like. For the merchant's customers who have a payment due during the requested loan period these customers may be unbanked or under-banked and so the external sources of information may be less traditional; initially any past repayment information can come from the merchant himself/herself but as the model is in use over a period of time the model itself can build up its own database per customer of repayment history, at least with this merchant and any other merchants that have extended credit to that same customer and used the same model with that same customer in the repayment control 321. This specific information input at 331 of FIG. 3 can include account balance information, amount in the account, past transactions (amount spent, type of store, category of purchase), past credit history and score, payments history, pending payments and total outstanding amounts with respect to previous outstanding amounts. Additional personal information can be also provided such as gender, age, address, family information and the like.

Finally the credit score model 320 can operate to compute the new credit score based on bundle of debt. This model is created based on the customer debit/repayment control 321, for example was payment made on the day agreed, was it in full or in part, how many transactions has this customer had, what is the value of his/her purchases, and the like. This information can be retrieved from the databases and it can be refined periodically, as may be configured by the system administrator. When a request for credit 301 arrives, the model 320 is used to compute the creditworthiness of the set of users or bundle, based on the provided information per customer 321 where the specific customers to use for the model 320 are selected for a particular credit request 301. As noted above, the model 320 can use statistical methods, machine learning and/or artificial intelligence.

One aspect of the model's analysis of the merchant's selected customers is shown in the rightmost column of FIG. 4, the score. For each individual customer the model uses that same customer's previous payment history (with this same merchant or with other merchants) as well as other repayment risk information such as changes to employment status or income if known, total current outstanding debt in relation to the amount currently owed to this merchant, previous total debt levels when previous debt repayments were made on time or late and/or partially or in full, and the like) to calculate a score for that individual customer. In this regard the customer-specific score may be considered as a weighting factor or risk factor corresponding to the likelihood that the amounts due to the merchant during the merchant's requested repayment period will be repaid as scheduled. While a conventional risk analysis for merchant credit might discount the merchant's projected amounts from current sales, the customer-specific score can be considered as a risk adjustment factor by which to discount that customer's scheduled repayments to the merchant. FIG. 4 assumes a simple scale of zero to 1.0, with a score of 1.0 representing there is no risk the customer will not repay in full and on schedule while a score of zero represents that the entire repayment is to be discounted and not contribute to raising the new credit score 340 for this requested loan. In this regard Maria's score of 0.8 as compared to João's score of 0.5 reflects that the model finds Maria is more likely than João to repay in full and on schedule as shown in FIG. 4.

First the model selects all of the customers/debtors who have at least one payment due to the merchant during the total repayment period of the merchant's credit request. Then these selected customers/debtors are ranked based on their individual score and their individual repayments due to the merchant. Then the model makes a further selection among these ranked customers/debtors for each of the installment periods/due dates of the merchant's credit request, beginning with the highest ranked debtor, until the payment amounts due from all these further selected debtors equals the merchant's payment amount for the given installment period of the merchant's credit request. It is this further selection of customers/debtors whose individual scores are used to compute the bundle score.

The bundle score aggregates at least the risk assessed concerning repayment by the selected customers, and in some embodiments such as is shown at FIG. 4 it can also incorporate risk in the cash flow analysis to account for the possibility that the merchant may not meet its sales forecasts through the entire repayment period. In the FIG. 4 example the merchant is Junior who sells baked goods to neighborhood bodegas (e.g., his customers Maria, João', etc.), and he is requesting a loan in the amount of $500 to be repaid in 3 monthly installments for a new oven so he can expand his business. For simplicity assume there is no interest charged on that loan, meaning each installment payment would be $166.67. FIG. 4 shows that Junior's cash flow should support that loan; the excess $13.33 free cash flow at each of the 30-day and 60-day payment dates can be carried over to make up the cash flow shortfall at the 90-day payment date.

In order to have cash to pay the loan, Junior depends on the repayment from Maria, João, José and Carol at each of the 30-day, 60-day and 90-day. So, the system uses the individual credit score from each customer (in this example Maria 0.8, João 0.5, José 0.7 and Carol 0.9) to compute the final bundle credit score for Junior that will be 0.8. One embodiment is to use all the customer's individual scores that will pay during the repayment period to compute the final bundle score. Another embodiment makes a further selection among these ranked customers/debtors for each of the installment periods/due dates of the merchant's credit request, beginning with the highest ranked debtor, until the payment amounts due from all these further selected debtors equals the merchant's payment amount for the given installment period of the merchant's credit request.

The output of processing these various inputs by the model 320 is a new credit score 340. In FIG. 3 the new credit score 340 is shown as a separate component for clarity of explanation; it receives the score from the model 320 and sends it to another software application 341. Depending on the final score, the system 300 may approve or reject the credit request, or suggest an alternative/modified amount that would be approved given the model's analysis of th is set of customers and their respective repayment information (and also the other inputs). In general this approve/reject decision can be thought of as a threshold which is adjustable based on the credit request; the requested credit is approved if the new credit score or the bundle score is higher than the corresponding threshold. So for example in the above FIG. 4 the loan request for $500 to be repaid in 3 installments might be scored by the model as 0.8 and the system may define a bundle score threshold for Junior as 0.75. So based on this threshold the system from the lender will approve the loan request. The threshold may be defined per user or the same for all users.

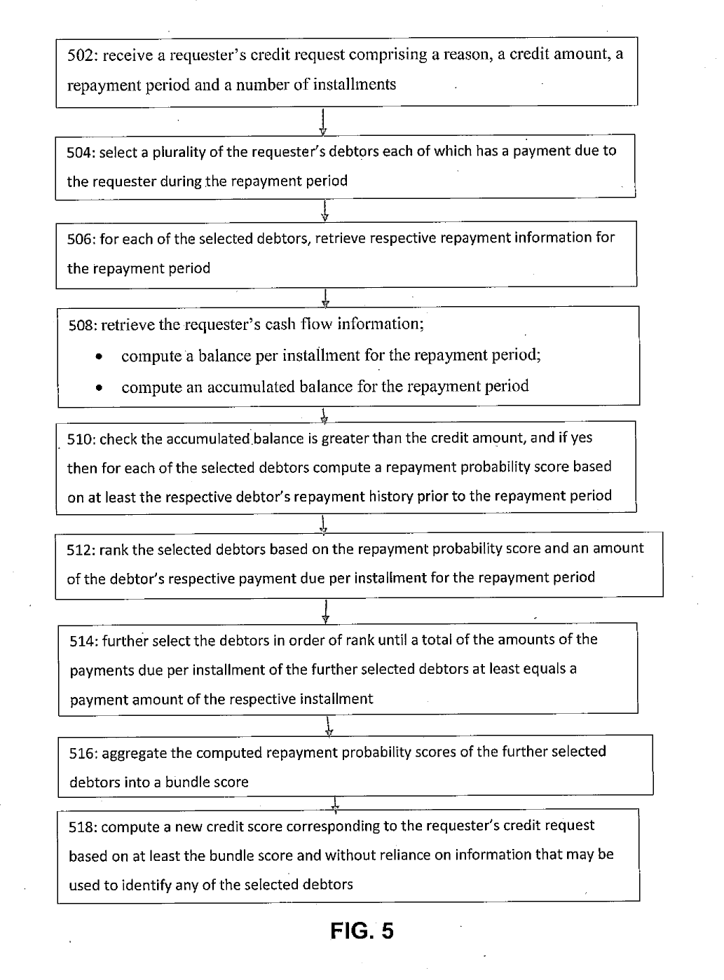

FIG. 5 is a logic flow diagram that summarizes certain of the above-described features of the embodiments of this invention. At block 502 a requester's credit request comprising a reason, a credit amount, a repayment period and a number of installments are received, and in FIG. 3 this was the credit request 301 received at the request interface 310 of the local device 300. The remainder of FIG. 5 is in response to the request at block 502.

Specifically, at block 504 a plurality of the requester's debtors are selected, those debtors which have a payment due to the requester during the repayment period. In the FIG. 4 example the repayment period was 90 days, there were 3 installments and the selected debtors were Maria, João, Ana, José and Carol because each of them had a payment due to Junior during that total 90 day period, and in FIG. 3 this was shown as the repayment control per customer 321.

Block 506 retrieves the respective repayment information for the repayment period for each of the debtors that were selected at block 504. These are shown in FIG. 4 as the individual amounts due from the customers/debtors that are entered in the 30, 60 and 90 day columns, and in FIG. 3 this was also part of the repayment control 321.

Block 508 retrieves the requester's cash flow information such as the periodic total cash inflows and outflows at FIG. 4, from which is computed a balance per installment (the Total row in FIG. 4). There is also computed an accumulated balance for the repayment period, which is not shown in FIG. 4 but would be $180+$180+$150=$510 for the FIG. 4 example. This is compared against the requested credit amount as a check; if the requester's total undiscounted cash flow over the repayment term is not sufficient it is not usually worthwhile to continue with the scoring calculations.

There is a repayment probability score per debtor that is computed at block 510 for the case where the accumulated balance is greater than the amount of the credit request, which is based on at least the respective debtor's repayment history prior to the repayment period. If for an individual customer/debtor there is no repayment history available (for example, this merchant/requester has never extended credit to this customer/debtor prior to the existing debt) then basing the probability score for this particular customer/debtor on the fact that there is no repayment history for him/her is sufficient. If any of the customers/debtors have traditional banking history the traditional credit reporting data can be gathered at 331 of FIG. 3, but otherwise the history with this requester at least will be included with the repayment control information 321 of FIG. 3. Examples of these repayment probability scores are shown in the rightmost column of FIG. 4 in the rows corresponding to the individual customers/debtors Maria, João, Ana, José and Carol.

Now there is a further selection among the customers/debtors to arrive at only those whose payments to the requester/merchant will be supporting the merchant's credit request. At block 512 the debtors from block 504 are ranked, based on their respective probability score and the amount of their respective payments due per installment. Then at block 514 there is a further selection from among these ranked debtors, and this further selection is in order of rank until a total of the amounts of the payments due per installment of the further selected debtors at least equals a payment amount of the respective installment. This is done over the entire repayment period to ensure there are enough debtors to support the merchant's repayment of each of the installment amounts.

Finally the repayment probability scores from block 510, of the debtors that are further selected at block 514, are aggregated into a bundle score at block 516. An example of such a bundle score is explicitly shown at FIG. 4.

Block 518 of FIG. 5 completes the process by computing a new credit score corresponding to the requester's credit request of block 502. This new credit score is based on at least the bundle score and is computed without reliance on information that may be used to identify any of the selected debtors. So for example if there was some traditional credit history information available for Maria and it was fetched with the data 331 of FIG. 3, that traditional history information can be used to compute Maria's repayment probability score at block 508 but when computing the new credit score for Junior's credit request for $500 there will be nothing that identifies Maria as an individual; her contribution to Junior's ability to repay that requested $500 loan is reflected only in the cash flow totals corresponding to Junior's 30, 60 and 90 day installment payment dates, and in the bundle score. In this manner each and every one of Junior's customers/debtors remains anonymous to the credit lending facility/credit provider, and even in the calculation of Junior's new credit score.

In the FIG. 4 example the periodic cash flow projections for Junior (the requester) during the 90-day repayment period were computed (or retrieved, if for example they are taken from Junior's accounting software) such that there is a periodic cash flow value corresponding to each installment due date within the repayment period. Specifically, the periodic cash flow values for the installment due dates are the total values $180, $180 and $150 for the respective 30, 60 and 90 day installment due dates in FIG. 4. This is from the cash flow information which includes at least sales forecasts and cash outflow such as payroll, utilities, rent and supplies. The installment due dates assume Junior's loan is approved. In this case of course the new credit score is computed based on the cash flow information (for example, those projected periodic cash flow values) and the bundle score. While the FIG. 4 example has the payments due to the requester during the repayment period by the selected debtors incorporated into the cash flow information/the projected periodic cash flow values, in other implementations the cash flow values can be determined in the absence of these debtor repayments (e.g., current sales cash flow projections only) and these current sales only cash flow values can be provided along with the bundle score and the aggregated payments due per installment due date/interval, but this is a bit less anonymous for the customers/debtors in certain cases because it may be that in a given installment interval Junior has only one payment due from only one customer/debtor.

In the FIG. 4 example in which the cash flow values did incorporate the debtor's payments due. The software implementing certain embodiments of these teachings can output the new credit score (based on the bundle score at block 512 of FIG. 5) and information about the requester, for example only after checking that for each installment due date the projected periodic cash flow value exceeds the corresponding installment amount.

In one implementation different from that shown at FIG. 3 the new credit score module 340 is in a separate device from the illustrated local device 300. In this case the bundle score as well as information about the requester (for example, the data gathered at 331 or at least enough information about the requester so that the separate device can gather such data from traditional credit reporting. agencies) can be output from the local computing device 300 and communicated, without information that may be used to identify any of the selected debtors, to a separate computing device which computes the new credit score. In this case the separate computing device may be at the credit facility/credit provider, in which case it may directly and tangibly output to a graphical display screen or a printed page for example an indication of approval or disapproval of the requester's credit request.

The present invention may be implemented as a system, a method, and/or a computer program product. The computer program product may include a computer readable storage medium (or media) such as a memory having computer readable program instructions stored thereon for causing a processor to carry out certain aspects of the present invention.

The computer readable storage medium such as the memory can be a tangible device that can retain and store instructions for use by an instruction execution device (such as the data processor(s) of the computer, as shown as the credit score module 320 and/or the data analyzer 330 of FIG. 3). The computer readable storage medium may be on a same or different chip as the data processor, and for example may be but is not limited to an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As such, various modifications and adaptations may become apparent to those skilled in the relevant arts in view of the foregoing description, when read in conjunction with the accompanying drawings and the appended claims. As but some examples, the use of other similar or equivalent vulnerability types may be used by those skilled in the art. However, all such and similar modifications of the teachings of this invention will still fall within the scope of this invention.

1. A method performed on at least one computing device, the method comprising:
receiving a requester's credit request comprising a reason, a credit amount, a repayment period and a number of installments; and in response
selecting a plurality of the requester's debtors each of which has a payment due to the requester during the repayment period;
retrieving, for each of the selected debtors, respective repayment information for the repayment period;
retrieving the requester's cash flow information;
computing a balance per installment for the repayment period;
computing an accumulated balance for the repayment period;
for the case in which the accumulated balance is greater than the credit amount of the request, computing, for each of the selected debtors, a repayment probability score based on at least the respective debtor's repayment history prior to the repayment period;
ranking the selected debtors based on the repayment probability score and an amount of the debtor's respective payment due per installment for the repayment period;
further selecting the debtors in order of rank until a total of the amounts of the payments due per installment of the further selected debtors at least equals a payment amount of the respective installment;
aggregating the computed repayment probability scores of the further selected debtors into a bundle score; and
computing a new credit score corresponding to the requester's credit request based on at least the bundle score and without reliance on information that may be used to identify any of the selected debtors.

2. The method according to claim 1, wherein the retrieved cash flow information includes sales forecasts and cash outflow of at least payroll, utilities, rent and supplies;
and wherein the new credit score is computed based on the cash flow information and the bundle score.

3. The method according to claim 1, wherein said cash flow information incorporates the payments due to the requester during the repayment period by the selected debtors.

4. The method according to claim 3, further comprising outputting the new credit score along with information about the requester.

5. The method according to claim 1, wherein the bundle score and information about the requester is output from a local computing device and communicated, without information that may be used to identify any of the selected debtors, to a separate computing device which computes the new credit score.

6. The method according to claim 5, the method further comprising:
the separate computing device tangibly outputting an indication of approval or disapproval of the requester's credit request.

7. The method according to claim 1, wherein at least through computing the bundle score, the method is performed by at least one local device under control of the requester.

8. An apparatus comprising:
one or more memories comprising computer-readable code; and
one or more processors;
wherein the one or more processors are configured, in response to execution of the computer-readable code, to cause the apparatus to perform actions comprising:
receiving a requester's credit request comprising a reason, a credit amount, a repayment period and a number of installments; and in response
selecting a plurality of the requester's debtors each of which has a payment due to the requester during the repayment period;
retrieving, for each of the selected debtors, respective repayment information for the repayment period;
retrieving the requester's cash flow information;
computing a balance per installment for the repayment period;
computing an accumulated balance for the repayment period;
for the case in which the accumulated balance is greater than the credit amount of the request, computing, for each of the selected debtors, a repayment probability score based on at least the respective debtor's repayment history prior to the repayment period;
ranking the selected debtors based on the repayment probability score and an amount of the debtor's respective payment due per installment for the repayment period;
further selecting the debtors in order of rank until a total of the amounts of the payments due per installment of the further selected debtors at least equals a payment amount of the respective installment;
aggregating the computed repayment probability scores of the further selected debtors into a bundle score; and
computing a new credit score corresponding to the requester's credit request based on at least the bundle score and without reliance on information that may be used to identify any of the selected debtors.

9. The apparatus according to claim 8, wherein the retrieved cash flow information includes sales forecasts and cash outflow of at least payroll, utilities, rent and supplies;
and wherein the new credit score is computed based on the cash flow information and the bundle score.

10. The apparatus according to claim 8, wherein said cash flow information incorporates the payments due to the requester during the repayment period by the selected debtors.

11. The apparatus according to claim 10, the actions further comprising outputting the new credit score along with information about the requester.

12. The apparatus according to claim 8, wherein the bundle score and information about the requester is output from the apparatus which is a local computing device and communicated, without information that may be used to identify any of the selected debtors, to a separate computing device which computes the new credit score.

13. The apparatus according to claim 12, the actions further comprising:
the separate computing device tangibly outputting an indication of approval or disapproval of the requester's credit request.

14. The apparatus according to claim 8, wherein the apparatus performing at least through computing the bundle score is under control of the requester.

15. A computer readable memory storing program code that is executable by a computing system to cause the computing system to perform at least:
receiving a requester's credit request comprising a reason, a credit amount, a repayment period and a number of installments; and in response
selecting a plurality of the requester's debtors each of which has a payment due to the requester during the repayment period;
retrieving, for each of the selected debtors, respective repayment information for the repayment period;
retrieving the requester's cash flow information;
computing a balance per installment for the repayment period;
computing an accumulated balance for the repayment period;
for the case in which the accumulated balance is greater than the credit amount of the request, computing, for each of the selected debtors, a repayment probability score based on at least the respective debtor's repayment history prior to the repayment period;
ranking the selected debtors based on the repayment probability score and an amount of the debtor's respective payment due per installment for the repayment period;
further selecting the debtors in order of rank until a total of the amounts of the payments due per installment of the further selected debtors at least equals a payment amount of the respective installment;
aggregating the computed repayment probability scores of the further selected debtors into a bundle score; and
computing a new credit score corresponding to the requester's credit request based on at least the bundle score and without reliance on information that may be used to identify any of the selected debtors.

16. The computer readable memory according to claim 15, wherein the retrieved cash flow information includes sales forecasts and cash outflow of at least payroll, utilities, rent and supplies;
and wherein the new credit score is computed based on the cash flow information and the bundle score.

17. The computer readable memory according to claim 15, wherein said cash flow information incorporates the payments due to the requester during the repayment period by the selected debtors.

18. The computer readable memory according to claim 17, the program code when executed further causing the computing system to output the new credit score along with information about the requester.

19. The computer readable memory according to claim 1, wherein the bundle score and information about the requester is output from a local computing device and communicated, without information that may be used to identify any of the selected debtors, to a separate computing device which computes the new credit score.

20. The computer readable memory according to claim 5, the program code when executed further causing the computing system to tangibly output from the separate computing device an indication of approval or disapproval of the requester's credit request.
